(19) United States
(12) Patent Application Publication
(10) Pub. No.: US 2007/0142589 A1
(43) Pub. Date: Jun. 21, 2007

(54) Process and systems for the efficient production of polymeric microspheres

(76) Inventors: Martin E. Rogers, Blacksburg, VA (US); Janice Paige Phillips, Hattiesburg, MS (US); Bryan Koene, Blacksburg, VA (US)

Correspondence Address: NIXON & VANDERHYE, PC, 901 NORTH GLEBE ROAD, 11TH FLOOR, ARLINGTON, VA, 22203, US

(21) Appl. No.: 10/590,454

(22) PCT Filed: Feb. 23, 2005
(86) PCT No.: PCT/US05/05617

§ 371 Date: Aug. 24, 2006

Related U.S. Application Data
(60) Provisional application No. 60/546,937, filed on Feb. 24, 2004.

(51) Int. Cl. C08F 120/00; B01J 19/00

(52) U.S. Cl. 526/303.1; 526/317.1; 526/319; 526/346; 422/186.3; 422/129

(57) ABSTRACT

Processes and systems are provided whereby continuous polymeric microspheres are made by nebulizing a solventless initiated monomeric liquid (that is a liquid solution comprising a monomer and a polymerization initiator for the monomer) to form an aerosol of polymerization-initiated monomeric liquid droplets within a gas-filled reaction zone. The nebulized droplets of the monomeric liquid are allowed to fall under gravitational force through the reaction zone and to polymerize therewithin. The thus polymerized particles may thereafter be collected and removed from the reaction zone for further processing and/or use as may be desired.

### CROSS-REFERENCE TO RELATED APPLICATION

This application is based on, and claims domestic priority benefits under 35 USC §119(e) from, U.S. Provisional Patent Application Ser. No. 60/546,937 filed on Feb. 24, 2004, the entire content of which is expressly incorporated hereinto by reference.

### FIELD OF THE INVENTION

The present invention relates to processes and systems for the production of small polymeric particles, conventionally termed “microspheres”. In especially preferred embodiments, the present invention is directed toward processes and systems whereby polymeric microspheres may be produced in an efficient and cost-effective manner.

### BACKGROUND OF THE INVENTION

Polymeric microspheres (i.e., polymeric particles having an average particle size of between about 100 nanometers to about 500 microns, and typically between about 200 nanometers to about 100 microns) are being studied in a wide variety of applications including pharmaceuticals, coatings, additives for plastics formulations and food, and agricultural products. While microspheres are currently manufactured and sold commercially, widespread implementation of polymeric microsphere technology is limited by production costs. Traditional dispersion methods of microsphere production involve large amounts of volatile organic compounds and waste water and have limited production output as they are generally batch processes.

Dispersion polymerization is currently the primary method for making polymeric microspheres. In this regard, a water insoluble vinyl monomer is dispersed in water in an oil-in-water emulsion. In U.S. Pat. No. 4,446,261 to Yamasaki et al, there is disclosed a process for preparing water-insoluble high water-absorbent polymers beads by dispersing and suspending an aqueous solution of a water-soluble, ethylenically unsaturated monomer containing a small amount of a crosslinking agent in a dispersion medium of a hydrocarbon or a halogenated aromatic hydrocarbon. Liquid microspheres are formed in the dispersion process with particle size controlled by the oil monomer concentration, surfactant type and concentration and degree of mixing. Either an oil soluble or water soluble initiator initiates polymerization within the liquid microsphere when the emulsion is heated forming a solid particle. (Suzuki et al, “An Experimental Study on the Kinetics and Mechanisms of Styrene Polymerization in Oil-in-Water Microemulsion Initiated by Oil-Soluble Initiators”, Macromol. Symp., 155, 199-212 (2000))¹ Surfactant-free emulsion polymerization has been achieved by copolymerizing hydrophilic and hydrophobic monomers within the microspheres. (Wang et al, “Emulsifier-free Emulsion Polymerization of Styrene with Methacrylic Acid”, Appl. Polym. Sci., 88, 1747-1751 (2003)) Oil soluble monomers can also be dispersed and polymerized in alcoholic media to form microspheres. (Ho et al, “Dispersion Polymerization of Styrene in Alcoholic Media: Effect of Initiator Concentration, Solvent Polarity and Temperature on the Rate of Polymerization”, J. Polym. Sci.: Pt. A: Polym. Chem., 35, 2907-2915 (1997))
¹ The entire content of this publication and the entire content of each publication cited hereinafter are expressly incorporated into the subject application by reference thereto.

In a similar manner, water-in-oil emulsions are used to polymerize water soluble monomers. This is commonly used in making microspheres of polyacrylic acid or poly(acrylic acid-co-sodium acrylate). (Jiang et al, “Kinetics of the Potassium Persulfate-Initiated Inverse Emulsion Polymerization of Sodium Acrylate Solutions”, J. Polym. Sci.: Pt A: Polym. Chem., 34, 695-699 (1996), and Mayoux et al, “Inverse Suspension Polymerization of Sodium Acrylate: Synthesis and Characterization”, J. Appl. Polym. Sci., 77, 2621-2630 (2000).

Acylic acid is neutralized to a desired degree with aqueous sodium hydroxide. To make a hydrogel microsphere, a crosslinking agent such as N,N′-methylenebisacrylamide is added to the aqueous monomer solution. Potassium persulfate is a water soluble initiator that is generally dissolved in the monomer solution prior to dispersion. Particle size is controlled by the concentration of the aqueous monomer solution, surfactant type and concentration and the degree of mixing. Polymerization occurs within the liquid monomer droplets forming a solid microsphere.

Isolating dry microspheres from dispersion polymerization involves filtration and washing leaving large amounts of solvent or water waste. Isolation and waste treatment result in high costs for microsphere production. Solvent-less techniques have been investigated as alternative methods to producing microspheres.

Aerosol polymerization has been used to make microspheres via step-growth and chain-growth polymerization techniques. Polysiloxane particles have conventionally been produced using an evaporation-condensation route where vaporized monomer condense on a nuclei and polymerize when exposed to a second monomer vapor. (Shin et al, “Preparation of Polymer Particles in Aerosol-Phase Reaction”, Aerosol Science and Technology, 24, 243-254 (1996)) A similar method was used to produce polyurea microspheres with diameters of two microns and less. (Partch et al, “Preparation of Polymer Colloids by Chemical Reactions in Aerosols”, Journal of Colloid and Interface Science, 105(2), 560-569 (1985). Unfortunately, the evaporation-condensation route produces a low yield of microspheres.

Polystyrene microspheres have been produced by nebulizing styrene monomer and introducing the aerosol into a chamber containing a vaporized initiator (trifluoromethanesulfonic acid). (Shin et al, supra.) Spherical polystyrene microspheres were produced with diameters of 1-5 microns. Increasing attention has been given to the use of supercritical carbon dioxide as a “environmentally benign” solvent for making microspheres. (Matsuyama et al, “Environmentally Benign Formation of Polymeric Microspheres by Rapid Expansion of Supercritical Carbon Dioxide Solution with a Nonsolvent”, Environmental Science and Technology, 35, 4149-4155 (2001); Okubo et al, “Production of Polyacrylonitrile Particles by Precipitation Polymerization in Supercritical Carbon Dioxide”, Colloid and Polymer Science, 281, 964-972 (2003); and Jung et al, “Particle Design Using Supercritical Fluids: Literature and Patent Survey”, Journal of Supercritical Fluids, 179, 219 (2001)) While potentially an improvement over conventional dispersion polymerization techniques, supercritical CO₂ requires extensive capital equipment to control pressure and temperature.

Microspheres may be formed according to U.S. Pat. No. 4,929,400 to Rembaum et al by deploying a precisely formed liquid monomer droplet into a containerless environment. The droplets are levitated in the environment preferably by means of electrostatic forces. The droplets are also subjected to polymerizing radiation, such as ultraviolet or gamma radiation as they levitatingly travel through the environment.

U.S. Pat. No. 6,313,199 to Davies et al disclose processes for spray drying water-soluble and water swellable vinyl-addition polymer-containing dispersions, emulsions and microemulsions to obtain substantially dry water-soluble or water-swellable polymer particles. According to Davies et al '199, a vinyl-addition polymer-containing dispersion, water-in-oil emulsion or water-in oil microemulsion is spray-dried in a gas stream at elevated temperatures, with the spary-dried polymer particles thereafter being collected.

A process for preparing nanoparticles and microparticles is provided by U.S. Pat. No. 6,616,869 to Mathiowitz et al wherein a mixture of a polymer and a solvent is formed, with the solvent being present in a continuous phase. The mixture is introduced into an effective amount of a nonsolvent which causes the spontaneous formation of microparticles.

According to U.S. Pat. No. 6,767,720 to Pui et al, particle sprays are formed from nozzle structures by creating a nonuniform electrical field between the nozzle structures and an electrode electrically isolated therefrom.

### SUMMARY OF THE INVENTION

Improvements in the microsphere production process are needed to lower cost and enable widespread use. Therefore, it is one object of this invention to provide processes which enable polymeric microspheres to be produced continuously on a cost-effective basis.

Broadly, the present invention is embodied in processes and systems whereby continuous polymeric microspheres are made by nebulizing a solventless initiated monomeric liquid (that is a liquid solution comprising a monomer and a polymerization initiator for the monomer) to form an aerosol of polymerization-initiated monomeric liquid droplets within a gas-filled reaction zone, and allowing the nebulized droplets of the monomeric liquid to fall under gravitational force through the reaction zone and to polymerize therewithin. The thus polymerized particles may thereafter be collected and removed from the reaction zone for further processing and/or use as may be desired.

According to one particularly preferred embodiment of the invention, processes and systems are provided for producing polymeric microspheres by generating an aerosol of initiated liquid monomeric droplets, and allowing the aerosol of initiated liquid monomeric droplets to gravitationally fall through an inert gas-filled reaction zone under polymerization reaction conditions and for a time sufficient to substantially polymerize the monomeric droplets and form polymeric microspheres. The resulting microspheres are then collected the polymeric microspheres.

The initiated liquid monomeric droplets are most preferably generated by passing an initiated liquid monomeric solution through a nebulizer and thus allowing the nebulizer to generate the droplet aerosol.

The nebulizer may be positioned near an upper end of a reactor tube which defines the reaction zone. As such, the aerosol of droplets is allowed to fall by gravity through the reaction zone to a lower end of the reactor tube. Alternatively, the nebulizer may be positioned near a lower end of a reactor tube which defines the reaction zone so as to create an upwardly directed plume of droplets. The droplets in the upwardly directed plume will thus be propelled initially upwardly through the reaction zone against gravitational force, and then reverse direction under the influence of gravitational force so that the droplets thereafter fall by gravity through the reaction zone.

The reaction zone may be heated, for example, by the introduction of heated air into the reaction zone. Heating of the reaction zone may also be accomplished by means of electrical resistance heaters and/or a heat exchange medium.

For liquid monomeric solutions containing photoinitiators, the present invention may include at least one ultraviolet (UV) light positioned adjacent the reaction zone. In such an embodiment, the reactor tube will have a UV light transparent window to allow the UV light to enter the tube in the reaction zone. Preferably, a pair of opposed UV lights are provided.

These and other aspects, advantages and/or objects of the invention will become more clear after careful consideration is given to the following detailed description of the preferred exemplary embodiments thereof.

### BRIEF DESCRIPTION OF THE ACCOMPANYING DRAWINGS

Reference will hereinafter be made to the accompanying drawings, wherein like reference numerals throughout the various FIGURES denote like structural elements, and wherein;

FIG. 1 is schematic representation of one embodiment in accordance with the present invention showing a system that may be employed to make polymeric microspheres;

FIG. 2 is a schematic representation of another embodiment in accordance with the present invention showing another system that may be employed to make polymeric microspheres;

FIG. 3 is a schematic representation of yet another embodiment in accordance with the present invention showing another system that may be employed to make polymeric microspheres; and

FIGS. 4a and 4b are photomicrographs showing microspheres which were produced in accordance with the Examples below.

### DETAILED DESCRIPTION OF THE INVENTION

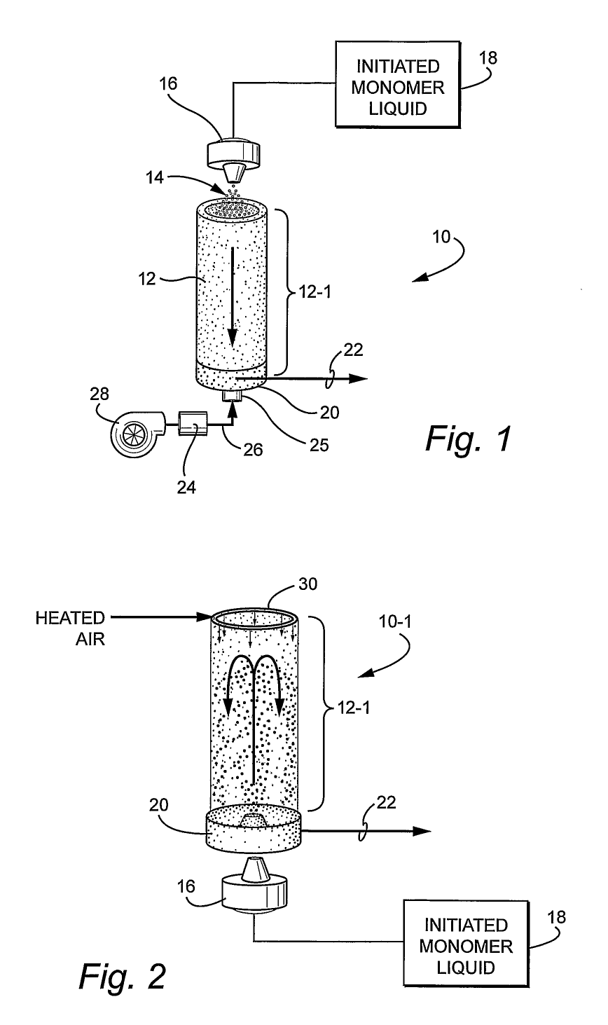

A schematic of one presently preferred aerosol polymerization system 10 in accordance with the present invention is shown in accompanying FIG. 1. As shown, the aerosol polymerization system 10 is comprised of a modular vertical tube 12 which defines the polymerization zone 12-1 for the aerosolized droplets 14 of initiated monomeric liquid. A nebulizer 16 is positioned near the upper end of the tube 12 so as to create an aerosol of fine droplets 14 from the supply 18 of initiated monomeric liquid, and to disperse the droplets 14 into the polymerization zone 12-1 defined by the tube 12. A collection plate 20 is positioned at the bottom of the vertical tube to collect and contain the resulting polymeric microspheres. Alternatively or additionally, the resulting polymeric microspheres may be directed to another location for storage and/or treatment, for example, by means of a pneumatic conveyance via line 22 shown in FIG. 1.

The temperature within the reaction zone 12-1 may be elevated by any suitable means. Thus, for example, air heated by a heating unit 24 may be introduced into an air intake duct 25 provided below the collection plate via line 26. A blower 28 provides the motive force to the heated air so it can be introduced physically into the interior of the tube 12 at the desired velocity. The tube 12-1 may optionally or additionally be heated by means of electrical resistance heaters and/or by means of a heat-exchange medium which are not shown but which are well known heating means to those skilled in the art. The heated reaction zone 12-1 will thus provide a temperature environment for the initiated monomeric droplets that will ensure polymerization during the residence time therein.

As depicted in FIG. 1, the nebulizer of the aerosol generator is most preferably placed vertically above the tube so as to direct the resultant aerosol of droplets 14 downwardly into the reaction zone. The aerosol or droplets 14 will thus flow downwardly within the vertical tube under the influence of gravitational force and will collect at the bottom plate 20. The length of the tube 12 and/or the velocity of heated air being introduced in counter-current flow to the gravitationally descending aerosol of droplets 14 is selected so as to achieve the requisite residence time within the reaction zone 12-1 and thereby ensure that the microspheres collected at the bottom plate 20 are substantially, and preferably completely, polymerized.

Alternatively, the nebulizer 16 may be positioned at the bottom end of the tube 12 as shown by the system 10-1 in accompanying FIG. 2 so as to direct the aerosol flow of droplets 14 initially upwardly within the reaction zone against gravitational force. Subsequently, of course, the velocity of the aerosolized droplets 14 will decay under the influence of gravitational force to a point whereby the droplets 14 reverse direction and then gravitationally fall downwardly within the tube 12. The system 10-1 shown in FIG. 2 is especially preferred for those polymers whereby an increase in the residence time of the aerosol within the reaction zone 12-1 is desired without increasing the length of the tube 12.

Heated air may be supplied to the reaction zone 12-1 in the system 10-1 of FIG. 2 using similar means to that described previously in connection with the system 10 of FIG. 1. In this regard, the flow of heated air in the system 10-1 depicted in FIG. 2 is most preferably accomplished by means of a gas diffusion ring 30 which includes several circumferentially separated outlet ports (not shown) to direct respective streams of heated air generally downwardly along the sides of the interior tube wall. The gas diffusion ring 30 will direct airflow down the interior walls of the tube 12 thereby causing the path of the aerosolized droplets 14 rising generally upwardly in the central region within the tube 12 to be directed radially outwardly toward the periphery of the reaction zone 12-1 and thereafter descend by gravity near the interior wall of the tube 12 to the collection plate 20.

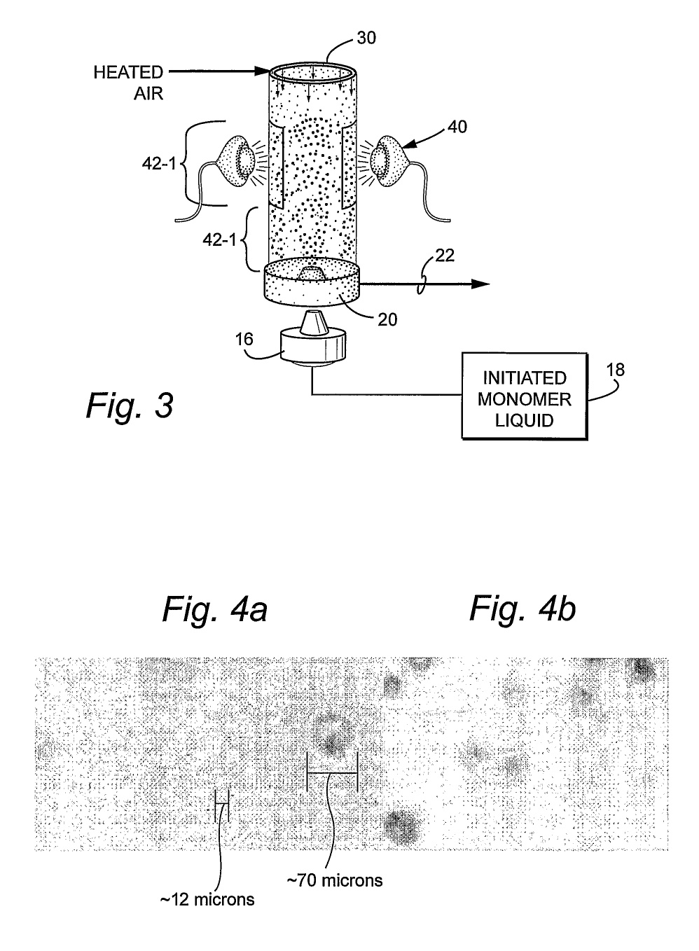

Another embodiment of a system 10-3 in accordance with the present invention is depicted in accompanying FIG. 3. As can be seen, the system 10-3 depicted in FIG. 2 generally includes the use of a ultraviolet (UV) light initiation mechanism for the aerosol polymerization as compared to the thermal initiation techniques described previously with respect to the systems 10 and 10-1 of FIGS. 1 and 2, respectively. The system 10-3 of FIG. 3 may be advantageous since UV initiation of the monomeric liquid could possibly minimize (or eliminate entirely) the need to heat the tube thereby resulting in reduced production costs.

The system 10-3 shown in FIG. 3 is structurally and functionally similar to the system 10-2 shown in FIG. 2, except that one or more ultraviolet (UV) lamps 40 are placed adjacent a UV transparent window 42 in the exterior wall of the tube 12. In addition, the UV lamp 40 and its associated window 42 are positioned near the top of the plume of aerosolized droplets 14 (that is, adjacent the location where the direction of the aerosolized droplets reverse from being directed upwardly against gravitational force to being directed downwardly with gravitational force). The aerosolized droplets 14 are therefore caused to be propelled out of the nebulizer 16 and initially upwardly through the UV light zone 42-1 established by the window 42. Thereafter, the aerosolized droplets 14 reverse direction and then fall by gravity back through the UV light zone 42-1 thereby increasing droplet exposure time to the UV light. Optionally, the bottom zone 42-2 can be heated to maintain or increase and/or control the polymerization rate of the monomeric liquid droplets 14. Airflow is most preferably generated down the interior wall of the tube 12 using a gas diffusion ring 30 similar to that discussed previously in connection with FIG. 2.

Virtually any conventional UV light source 40 may be employed satisfactorily in the present invention. Thus, UV light can be provided by means of a conventional medium pressure mercury lamp operatively positioned with respect to the exterior wall of the tube 12. Preferably, there are at least two UV lamps 40 positioned diametrically opposite to one another as depicted in FIG. 3. However, any number of UV lamps 40 may be positioned around the circumferential exterior of the tube 12 as may be desired. In such a manner, therefore, photopolymerization can be conducted in accordance with the present invention by the addition of a photoinitiator to the vinyl monomeric liquid supplied to the nebulizer 16.

The initiated monomeric liquid that is supplied to the nebulizer 16 is conveniently made by mixing polymerization initiation effective amounts of an initiator with a corresponding liquid monomer.

In this regard, suitable liquid monomers that may be employed in the practice of this invention include monomers used in the preparation of superabsorbent polymers such as acrylic acid, acrylamide and/or other monomers as disclosed in U.S. Pat. No. 5,669,894 (the entire content of which is expressly incorporated hereinto by reference). Poly(ethylene glycol) macromonomers having a number average molecular weight of from 300 to 10,000 g/mole and having at least on average of 0.5 ethylenic unsaturation per molecule may also be employed.

Other vinyl monomers can be used including (meth)acrylic esters such as (meth)acrylic alkyl or cycloalkyl esters having up to 20 carbon atoms in the alkyl radical, (meth)acrylamides, monomers containing epoxide groups; vinylaromatic hydrocarbons; monomers which carry per molecule at least one hydroxyl, thio, amino, alkoxymethylamino, carbamate, allophanate or imino group. Examples of vinyl monomers useful in the present invention are disclosed in U.S. Pat. No. 6,852,821 (the entire content of which is expressly incorporated hereinto by reference).

Particles can be made from combinations of various vinyl monomers in any manner reasonable in order to form copolymers. For example, the vinyl monomers can be combined with multifunctional monomers or oligomers resulting in crosslinked particles even to the point of gellation within the particle. Such multifunctional monomers or oligomers most preferably have at least two ethylenic unsaturations and include those disclosed in U.S. Pat. Nos. 6,846,564 and 6,762,240 (the entire contents of each being incorporated expressly hereinto by reference) as well as divinyl benzene and derivatives thereof.

For processes involving a heated reaction zone, polymerization of vinyl monomers is most preferably carried out in the presence of free radical initiators. Suitable initiators can include, for example, peroxide initiators, e.g. benzoyl peroxide, lauryl peroxide, cumyl peroxyneodecanoate or t-butyl peroxyneodecanoate, or an azo initiator, e.g. 2,2′-azobisisobutyronitrile, 2,2′-azobis(2-methylbutyronitrile), 2,2′-azobis(2,4-dimethylvaleronitrile), 1,1′-azobis(cyclohexane-1-carbonitrile), dimethyl 2,2′-azobis(2-methylpropionate)

For processes involving the use of UV light in the reaction zone, a photoinitiator is typically necessary in order to ensure curing of the composition. A photosensitizer may optionally be provided. Preferred photoinitiators include virtually any compound that decomposes upon irradiation and generates radicals to initiate the polymerization. Specific examples of suitable photoinitiators include acetophenone, acetophenone benzyl ketal, 1 hydroxycyclohexyl phenyl ketone, 2,2-dimethoxy-2-phenylacetophenone, xanthone, fluorenone, benzaldehyde, fluorene. anthraquinone, triphenylamine, carbazole, 3-methylacetophenone, 4-chlorobenzophenone, 4,4′-dimethoxybenzophenone, 4,4′-diaminobenzophenone. Michler's ketone, benzoin propyl ether, benzoin ethyl ether, benzyl dimethyl ketal, 1-(4-isopropylphenyl)-2-hydroxy-2-methylpropan 1 one, 2-hydroxy-2-methyl-1-phenylpropan-1-one, thioxanthone, diethylthioxanthone, 2-isopropylthioxanthone, 2-chlorothioxanthone, 2-methyl-1-[4-(methylthio)phenyl]-2-morpholino-propan-1-one, 2,4,6-trimethylbenzoyl diphenylphosphine oxide, and bis-(2,6-dimethoxybenzoyl)-2,4,4-trimethylpentylphosphine oxide.

Examples of commercially available products that may be employed as a photoinitiator include IRGACURE® 184, 369, 651, 500, 819, 907, 784, 2959, CGI-1700, CGI-1750, CGI-1850, CG24-61, DAROCUR® 1116, 1173 (manufactured by Ciba Specialty Chemicals Co., Ltd.), LUCIRIN® TPO, LR8893, LR8970 (manufactured by BASF Corporation), UBECRYL® P36 (manufactured by UCB Co.).

Specific examples of suitable photosensitizers include triethylamine, diethylamine, N-methyldiethanoleamine, ethanolamine, 4-dimethylaminobenzoic acid, methyl 4-dimethylaminobenzoate, ethyl 4-dimethylaminobenzoate, and isoamyl 4 dimethylaminobenzoate. Commercially available products that may be employed as the optional photosensitizer include, UBECRYL® P102, 103, 104, and 105 (manufactured by UCB Co.).

Water may be present in the liquid monomer solution in an amount up to about 75%, preferably up to about 60%, and advantageously up to about 50%.

The temperature of the reaction zone and residence time the droplets 14 are in the reaction zone are of course selected based on the particular liquid monomer and initiator that is employed. In this regard, reaction zone temperatures of between about 30 to about 120° C. may be employed, with residence times ranging from between about 30 to about 1800 seconds. The temperature and/or residence time is selected, however, to ensure substantially complete reaction occurs within the reaction zone. By “substantially complete reaction” is meant that the resulting polymeric microspheres obtained by the practice of the present invention will contain less than 30 wt. %, more preferably less than about 20 wt. % of unreacted liquid monomer.

Although the gaseous environment within the tube 12 and its associated reaction zone has been described as heated air, it will be appreciated that other inert gases may be employed. Thus, argon, helium and like inert noble gases may be employed within the reaction tube 12 if desired.

The process of the present invention therefore results in the manufacture of polymeric microspheres without the use of a solvent which is amenable to large scale production. Microspheres can therefore be made available in large quantities at a greatly reduced cost as compared to that associated with conventional microsphere production technologies. Such reduced costs would therefore make the use of microspheres made by the present invention more conducive for use in a wide range of products in a variety of end-use applications, such as in agriculture (e.g., to assist in the irrigation of soil by use of absorbent polymeric microspheres), medical applications (e.g., microspheres used for the controlled and/or sustained release of a drug or other agent or as an embolic in embolotherapeutic techniques), food packaging (e.g., to trap excess fluids by use of absorbent polymeric microspheres), adhesives, body armor, building and construction (e.g. noise dampening, roof coatings, polymer concrete), paper manufacturing, foams and toys and recreation decorations (e.g., as a component part of commercial display designs, photography and film making products, hobbies, and sports activities).

The present invention will be further understood from the following non-limiting Examples.

### EXAMPLES

Acrylic acid (12.99 grams, 0.18 mole) was 37.5% neutralized with 13.5 ml of 5M NaOH. N,N′-methylenebisacrylamide (1.54 grams, 0.01 mole) was dissolved into the acrylic acid/sodium acrylate/water solution. The monomer solution contained 40% by weight water and 60% monomer. A 5% solution of potassium persulfate in water was also prepared. Potassium persulfate is a water soluble free radical initiator with a 10 hour half-life at 60° C. in water. The polymerization solution was prepared by adding 2.7 grams the 5% potassium persulfate solution to 26.032 grams of the monomer solution. The initiator concentration was 1% by weight.

The initiator/monomer solution was then sprayed with a plastic spray bottle through a hole in the oven ceiling through heated air of 50 to 80° C. onto heated glass plates. The distance from the spray bottle to the plate was approximately 43 cm. The plates were removed 60 seconds after spraying the monomer solution during which time the monomer solution gelled. The slides were observed under a microscope. Microscope observation of the slides revealed a combination of microspheres (irregular shaped) and larger droplets that had not polymerized in the air but impacted the slide and polymerized. FIGS. 4a and 4b are photomicrographs showing particles that were formed according to this Example. Specifically, FIG. 4a is a photograph showing microspheres having particle sizes on the order of about 12 microns that were formed, while FIG. 4b is a photomicrograph of microspheres that were formed with particles sizes up to about 70 microns.

A control slide was sprayed outside the oven (i.e. at room temperature) at the same distance and then inserted into the oven for 60 seconds. No particles were observed on the control slide.

The experiments described above reveal that initiation and gellation of acrylic acid/sodium acrylate solution occurs rapidly at moderate temperatures. As such, solventless aerosol polymerization of initiated monomeric solutions is possible.

While the present invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A process for producing polymeric microspheres comprising the steps of:
(a) generating an aerosol of initiated liquid monomeric droplets; and
(b) allowing the aerosol of initiated liquid monomeric droplets to gravitationally fall through an inert gas-filled reaction zone under polymerization reaction conditions and for a time sufficient to substantially polymerize the monomeric droplets and form polymeric microspheres; and
(c) collecting the polymeric microspheres.

2. The process of claim 1, wherein step (a) includes passing the initiated liquid monomeric droplets through a nebulizer and allowing the nebulizer to generate the droplet aerosol.

3. The process of claim 2, wherein step (a) includes positioning the nebulizer near an upper end of a reactor tube which defines the reaction zone, and wherein step (b) includes allowing the aerosol of droplets to fall by gravity through the reaction zone to a lower end of the reactor tube.

4. The process of claim 3, wherein step (c) includes collecting the polymeric microspheres at the lower end of the reactor tube.

5. The process of claim 1, wherein step (a) includes positioning the nebulizer near a lower end of a reactor tube which defines the reaction zone so as to create an upwardly directed plume of droplets, and wherein step (b) includes allowing the droplets in the upwardly directed plume to reverse direction under the influence of gravitational force so that the droplets thereafter fall by gravity through the reaction zone.

6. The process of any one of claims 1-5, which comprises introducing heated air into the reaction zone.

7. The process of any one of claims 1-5, which comprises positioning a least one ultraviolet (UV) light adjacent the reaction zone.

8. The process of claim 1, wherein step (a) comprises supplying to a nebulizer an initiated monomeric liquid comprised of a mixture of a monomer and a polymerization initiator for the monomer.

9. The process of claim 8, wherein the monomer is at least one selected from the group consisting of acrylic acid, acrylamide, poly(ethylene glycol) macromonomers, (meth)acrylic esters, (meth)acrylamides, epoxide group-containing monomers, vinylaromatic hydrocarbons and monomers having at least one at least one hydroxyl, thio, amino, alkoxymethylamino, carbamate, allophanate or imino group per molecule.

10. The process of claim 9, wherein the initiator includes a peroxide or azo initiator.

11. A system for producing polymeric microspheres comprising:
a reactor tube defining an inert gas-filled reaction zone;
a nebulizer for generating an aerosol of initiated liquid monomeric droplets; said nebulizer being positioned relative to the reactor tube to allow the aerosol of initiated liquid monomeric droplets to gravitationally fall through an inert gas-filled reaction zone under polymerization reaction conditions and for a time sufficient to substantially polymerize the monomeric droplets and form polymeric microspheres; and
a collector at a lower end of the reactor tube for collecting the polymeric microspheres.

12. The system of claim 11, wherein the nebulizer is positioned near an upper end of the reactor tube so as to allow the aerosol of droplets to fall by gravity through the reaction zone to a lower end of the reactor tube.

13. The system of claim 12, comprising a heater for heating air, and a blower for introducing the heated air into the reactor tube.

14. The system of claim 11, wherein the nebulizer is positioned near a lower end of the reactor tube so as to create an upwardly directed plume of droplets into the reaction zone, wherein the upwardly directed plume of droplets reverse direction under the influence of gravitational force so that the droplets thereafter fall by gravity through the reaction zone.

15. The system of claim 14, comprising a heater for heating air, and a blower for introducing the heated air into the reactor tube.

16. The system of claim 15, comprising a diffusion ring positioned at an upper end of the reactor tube, the diffusion ring receiving heated air via the blower and having a plurality of outlets for directing the heated air downwardly along an interior wall of the reactor tube.

17. The system of any one of claim 11, which comprises heating means for heating the reaction zone.

18. The system of claim 11, 12 or 14, which comprises at least one ultraviolet (UV) light adjacent the reaction zone.

19. The system of claim 18, wherein the reactor tube comprises at least one UV light window positioned between a respective UV light and the reaction zone.

20. The system of claim 18, comprising a pair of opposed UV lights positioned adjacent the reaction zone.
